(19) United States
(12) Patent Application Publication
(10) Pub. No.: US 2006/0057967 A1
(43) Pub. Date: Mar. 16, 2006

(54) Power supply control apparatus and power supply control method

(75) Inventor: Keita Shimada, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/226,220

(22) Filed: Sep. 15, 2005

(30) Foreign Application Priority Data
Sep. 16, 2004 (JP) 2004-270489

(51) Int. Cl. H04B 17/00

(52) U.S. Cl. 455/67.13; 455/69; 455/343.2

(57) ABSTRACT

A port power supplying control section instructs a power supply interface section to start power supply from a port to which a power receiving apparatus successfully detected by power receiving apparatus detection processing is connected. For each port, power supply from which is started, a power supply possible/impossible judgment section sequentially obtains the corresponding non-power-supply time zone from a table stored in a scheduling section, sequentially receives time data from a control section, and compares these. In the case that the time data is inside the range of the obtained non-power-supply time zone, the port power supplying control section is instructed to stop power supply from the corresponding port. In the case that the time data is outside the range of the non-power-supply time zone, a power receiving apparatus detection processing section is instructed to perform power receiving apparatus detection processing so that power supply from the corresponding port is resumed.

### BACKGROUND OF THE INVENTION

1. Technical Field of the Invention

The present invention relates to a power supply control apparatus and a power supply control method for supplying power to communication apparatuses connected thereto, and more particularly, to a power supply control apparatus and a power supply control method for supplying power to communication apparatuses using the connection terminals of connectors for connecting the communication apparatuses.

2. Description of the Related Art

The so-called phantom power supply technology for supplying power from one communication apparatus to other communication apparatuses using communication cables has been devised and put into practical use in numerous communication fields. For example, PoE (Power over Ethernet (registered trademark)) for supplying power via the Ethernet (registered trademark) in a LAN (Local Area Network) is such a technology, and communication apparatuses adopting the PoE are widely used.

This kind of power supply technology using communication cables is ideally suited for communication apparatuses that are not suited for local power supply using AC/DC (alternating current/direct current) adaptors, for example. As this kind of communication apparatus, for example, communication apparatuses being disposed in relatively large numbers so as to be distributed in one area and communication apparatuses whose power supplies are preferably controlled collectively in consideration of switching to standby power supplies at the time of power failure are available. In view of this, numerous PoE compatible apparatuses have come onto the market in the fields of access points through which wireless LAN terminals perform communication (hereinafter referred to as wireless LAN access points) and IP telephones for making calls via the IP (Internet Protocol) network using the VoIP (Voice over Internet Protocol) technology.

For example, in the case that a communication system is built in an office or a Hotspot (registered trademark) using a wireless LAN, it is desirable to install as many wireless LAN access points as possible so that the estimated maximum number of users can access the network without inconvenience. In this case, if local power supply is performed individually, the number of cables increases. However, by the adoption of PoE compatible apparatuses, only the number of communication cables inherently used for communication are required. Hence, the number of cables is halved, and the communication system can be built easily. Furthermore, it is advantageous in that cost reduction is made possible.

As a communication apparatus on the power supplying side (hereinafter referred to as a power supplying apparatus) that supplies power to a communication apparatus on the power receiving side (hereinafter referred to as a power receiving apparatus) via such a communication cable, a switching hub is available, for example, which is connected to a plurality of communication apparatuses or a private backbone network, such as an IP network, and carries out data relay.

However, in such a communication apparatus performing data relay, its communication cable is usually made connectable and disconnectable as desired using a connector to provide flexibility in building a network. In many cases, it is uncertain which connector is connected to a power receiving apparatus to which power should be supplied. Hence, a communication apparatus not compatible with power reception is connected occasionally. If excessive or unnecessary power is supplied to the communication apparatus, the circuit of the communication terminal on the power receiving side may be damaged. If only insufficient power is supplied, the power receiving apparatus cannot be operated. In such a power supplying apparatus, for example, a relatively low pulse voltage is applied periodically to the power supply terminal, for supplying power to the power receiving apparatus, among the connection terminals of each connector. When a communication apparatus is newly connected to the connector via a communication cable, a judgment is made as to whether the communication apparatus is a power receiving apparatus or not. Such a sequence of processing for confirming whether such a power receiving apparatus is connected or not is referred to as power receiving apparatus detection processing. It is assumed that the judgment that power supply should be started for the power receiving apparatus and the connector for connecting the apparatus is a judgment stating that the power receiving apparatus detection processing has been performed successfully. When the power receiving apparatus detection processing has been performed successfully, power supply is started from the corresponding connector at that time, and the power receiving apparatus is ready to communicate.

Once a power receiving apparatus is connected to a power supplying apparatus, the power receiving apparatus remains connected continuously in many cases. This is because that, in the case of the above-mentioned wireless LAN access points, for example, the access points are installed at high places near the ceiling or on the backs of desks, and a switching hub accommodating such access points is also installed on the back of the ceiling. Furthermore, in a power receiving apparatus in which the power receiving apparatus detection processing has been performed once successfully, power supply is performed continuously in many cases, regardless of the subsequent communication state. This is because, in the case of an IP telephone or a wireless LAN access point, for example, it is necessary for the power receiving apparatus to stand by for reception from another communication apparatus accommodated in an IP network or in the same switching hub. Hence, even when no communication is performed, power for reception is consumed.

For this reason, as communication is performed less frequently, the power consumption ratio due to the standby power becomes higher in the entire power consumption of the power supplying apparatus. This problem is undesirable from the viewpoint of energy saving and cost reduction.

For the purpose of reducing standby power, a communication apparatus has been proposed conventionally which notifies, to a destination communication apparatus with which communication is performed, a time period during which the communication apparatus itself does not stand by for reception and the standby power is turned off (for example, Japanese Published Unexamined Patent Application No. 2002-202834 (Paragraph No. 0040 to Paragraph No. 0043, FIG. 4)). In this proposal, the communication apparatus transmits data and notifies, to another communication apparatus which may transmit return data thereto, a time period during which operation is performed in power saving mode wherein no data is received. Since the other communication apparatus does not return data during the time period notified as described above, the standby power is turned off during the time period notified, and power saving mode is set. Hence, in the case that it takes a long time until return data is transmitted, power consumption can be suppressed.

However, for the purpose of attaining power saving by applying this conventional proposal to a communication system in which phantom power supply is performed, each power receiving apparatus must be provided with a function of notifying the time period of the power saving mode and a function of turning off standby power. This makes each power receiving apparatus complicated, and in the case that the number of power receiving apparatuses is large, the installation cost of the entire system increases. Furthermore, in the case that communication apparatuses to be connected to a power supplying apparatus are unspecified, only the power receiving apparatuses having a power saving function are not necessarily connected. In the case that numerous power receiving apparatuses having no power saving function are connected, the effect of power saving is not obtained sufficiently. Hence, it is desirable that power saving can be realized by ingeniously designing only the apparatus on the power supplying side.

### SUMMARY OF THE INVENTION

The object of the present invention is to provide a power supply control apparatus and a power supply control method capable of realizing power saving by ingeniously designing only an apparatus on the power supplying side without particularly modifying the conventional configuration of a communication terminal on the power receiving side.

A power supply control apparatus according to a first aspect of the present invention (claim 1) comprises (a) one or a plurality of connectors, each provided with a plurality of connection terminals and part or all of the connection terminals being power supply terminals for supplying power to communication apparatuses to be connected, (b) a time zone data storage section for storing time zone data indicating time zones during which the power supply terminals corresponding to the one or plurality of connectors should stop power supply, (c) a clock for sequentially outputting time data, and (d) a power supply control section for comparing the time data with the time zone data stored in the time zone data storage section and for turning ON/OFF power supply depending on the result of the comparison, for respective power supply terminals of the connector.

In the first aspect of the present invention, the power supply control apparatus comprises one or a plurality of connectors, each provided with a plurality of connection terminals and part or all of the connection terminals being power supply terminals for supplying power to communication apparatuses to be connected. Time zone data indicating time zones during which the power supply terminals should stop power supply is stored so as to correspond to the respective connectors. Then, for respective power supply terminals of the connector, the time data output from the clock is compared with the corresponding time zone data stored, and power supply is turned ON/OFF depending on the result of the comparison. Hence, power supply to the connected communication apparatuses to which power is to be supplied can be started and stopped according to a predetermined schedule, without intermittently supplying power to the communication apparatuses. For example, a communication apparatus consumes power continuously to stand by for reception in many cases. However, in the case that it is predicted that reception is not performed or in the case that there is a time period during which it is determined that no reception is performed, even if power is supplied during the time period, there is a high possibility that the power supply becomes wasteful. Since the time zone data indicating such a time zone is stored, unnecessary power supply can be reduced, and power saving can be realized. In addition, this power saving can be realized by ingeniously designing only the apparatus on the power supply control apparatus side. Hence, in the case that there are numerous communication terminals to be connected, the cost of the entire communication system can be reduced when the above-mentioned power saving is realized.

A power supply control apparatus according to a second aspect of the present invention (claim 2) comprises (a) one or a plurality of connectors, each provided with a plurality of connection terminals and part or all of the connection terminals being power supply terminals for supplying power to communication apparatuses to be connected, (b) a power supply possible/impossible table for registering the possibility/impossibility of power supply in correspondence with the one or plurality of connectors, (c) a connection confirmation signal application section for applying a signal, for confirming the connection of a communication apparatus to which power is to be supplied, to the respective power supply terminals of each connector registered to be “power supply impossible” in the power supply possible/impossible table, (d) a power supply ON/OFF judgment section for sequentially judging whether power supply using each connector registered to be “power supply possible” in the power supply possible/impossible table is performed or not, (e) a first power supply possible/impossible table renewal section for renewing the content indicating that, when it is confirmed by the application of the connection confirmation signal from the connection confirmation signal application section that a communication apparatus to which power is to be supplied is connected, the connection of the communication apparatus to the corresponding connector registered in the power supply possible/impossible table is present, (f) a second power supply possible/impossible table renewal section for renewing the content indicating that, when it is judged by the power supply ON/OFF judgment section that power supply is not performed, power supply is impossible for the corresponding connector registered in the power supply possible/impossible table, (g) a time zone data storage section for storing time zone data indicating non-power-supply time zones each serving as a time zone during which the power supply terminals should stop power supply to the communication apparatus connected to each connector, in correspondence with the respective connectors, (h) a clock for sequentially outputting time data, and (i) a power supply control section wherein the time data is compared with the corresponding time zone data stored in the time zone data storage section for each connector registered to be “power supply possible” in the power supply possible/impossible table, power supply using the connector is turned ON/OFF according to the result of the comparison, and for each connector registered to be “power supply impossible” in the power supply possible/impossible table, power supply using the connector is not performed.

In the second aspect of the present invention, the power supply control apparatus comprises one or a plurality of connectors, each provided with a plurality of connection terminals and part or all of the connection terminals being power supply terminals for supplying power to communication apparatuses to be connected. In addition, the power supply possible/impossible table for registering the possibility/impossibility of power supply in correspondence with the respective connectors. Furthermore, in the case of each connector registered to be “power supply impossible” in the power supply possible/impossible table, a signal for confirming the connection of a communication apparatus to which power is to be supplied is applied to the power supply terminals of the connector. In the case of each connector registered to be “power supply possible,” a judgment is sequentially made as to whether power supply is performed or not. When it is confirmed that a communication apparatus to which power is to be supplied is connected, the content is renewed so as to indicate that the connection of the communication apparatus to the corresponding connector registered in the power supply possible/impossible table is present. When it is judged that power supply is not performed, the content is renewed so as to indicate that power supply is impossible. Furthermore, time zone data indicating non-power-supply time zones each serving as a time zone during which the respective power supply terminals of the corresponding connector should stop power supply is stored, and the time data is compared with the time zone data corresponding to the respective connectors registered to be “power supply possible” and power supply is turned ON/OFF according to the result of the comparison. On the other hand, for each connector registered to be “power supply impossible,” power supply using the connector is not performed. Hence, power is prevented from being supplied to an apparatus to which power is not to be supplied. Moreover, since power supply to the connected communication apparatuses to which power is to be supplied can be started and stopped according to a predetermined schedule, without intermittently supplying power to the communication apparatuses, power saving can be realized. Still further, this power saving can be realized by ingeniously designing only the apparatus on the power supply control side. Hence, in the case that there are numerous communication terminals to be connected, the cost of the entire communication system can be reduced in the case of realizing the above-mentioned power saving.

A power supply control apparatus according to a third aspect of the present invention (claim 6) comprises (a) one or a plurality of connectors, each provided with a plurality of connection terminals and part or all of the connection terminals being power supply terminals for supplying power to communication apparatuses to be connected, (b) a connection confirmation signal application section for applying a signal, for confirming the connection of a communication apparatus to which power is to be supplied at predetermined timing, to the power supply terminals of each connector, (c) a power supply start section for starting power supply using the corresponding connector when it is confirmed by the application of the connection confirmation signal from the connection confirmation signal application section that a communication apparatus to which power is to be supplied is connected, (d) a power threshold value storage section for storing, in correspondence with each connector, a power threshold value used as a criterion according to which it is judged that a communication apparatus connected to each connector requires power supply using the connector, (e) a time threshold value storage section for storing, in correspondence with each connector, a time threshold value used as a criterion according to which it is judged that the frequency in which a communication apparatus connected to each connector requires power supply using the connector is lowered to the extent that no trouble occurs even if the power supply is stopped, (f) an elapsed time measurement section for starting the measurement of elapsed time in correspondence with each connector to which power supply is started by the power supply start section, (g) a power measurement value section for sequentially measuring, for each connector, the value of supplied power using the power supply terminals of the connector at which the elapsed time measurement section started the measurement, (h) a power threshold value reaching judgment section for judging whether each power measurement value obtained by the power measurement value section has reached the corresponding power threshold value stored in the power threshold value storage section or not, (i) an elapsed time initialization section for instructing the elapsed time measurement section to initialize the time measurement value for the corresponding connector and to restart measurement when the power threshold value reaching judgment section judges that any one of the power measurement values has reached the corresponding power threshold value, (j) a time threshold value reaching judgment section for sequentially judging whether each time measurement value obtained by the elapsed time measurement section has reached the corresponding time threshold value stored in the time threshold value storage section or not, and (k) a power supply stop section for stopping power supply using the corresponding connector when the time threshold value reaching judgment section judges that any one of the time measurement values has reached the corresponding time threshold value.

In the third aspect of the present invention, power supply to each communication apparatus connected is stopped depending on the frequency in which power supply is required. The power supply control apparatus comprises one or a plurality of connectors, each provided with a plurality of connection terminals and part or all of the connection terminals being power supply terminals for supplying power to communication apparatuses to be connected. A signal for confirming the connection of a communication apparatus to which power is to be supplied at predetermined timing is applied to the respective power supply terminals. When it is confirmed that a communication apparatus to which power is to be supplied is connected, power supply using the corresponding connector is started. In addition, a power threshold value and a time threshold value used as criteria according to which it is judged that the frequency in which power supply is required to a communication apparatus connected to each connector is lowered to the extent that no trouble occurs even if the power supply is stopped are stored beforehand in correspondence with the respective connectors. Furthermore, the power supply control apparatus is provided with the elapsed time measurement section for starting the measurement of elapsed time in correspondence with each connector to which power supply is started, and the power measurement value section for sequentially measuring the power value supplied at each connector. A judgment is made sequentially as to whether the power measurement value of the power measurement value section has reached the corresponding power threshold value or not. When it is judged that the power measurement value has reached the threshold value, the elapsed time measurement section is instructed to initialize the time measurement value for the corresponding connector and to restart the measurement. Then, a judgment is made sequentially as to whether each time measurement value has reached the corresponding time threshold value or not. When it is judged that the time measurement value has reached the threshold value, that is, when the state wherein it is judged that any one of the communication terminals does not require power supply continues for the period of time set as the time threshold value, power supply using the corresponding connector is stopped. Hence, it is possible to reduce unnecessary power supply to a communication terminal having a low or lowered frequency of power supply required, and power saving can be realized.

A power supply control method according to a fourth aspect of the present invention (claim 8) comprises (a) a step of detecting a communication apparatus to which power is to be supplied when the communication apparatus is newly connected to one or any one of the a plurality of connectors, each provided with a plurality of connection terminals and part or all of the connection terminals being power supply terminals for supplying power to communication apparatuses to be connected, (b) a step of starting power supply, when it is detected by the connection detection that a communication apparatus to which power is to be supplied is newly connected to any one of the connectors, to the communication apparatus connected to the corresponding connector using the connector, (c) a step of sequentially comparing time data output from a clock with the corresponding time zone data in the time zone data indicating non-power-supply time zones each serving as a time zone during which respective power supply terminals should stop power supply, the time zone being stored in a time zone data storage section in correspondence with each connector to which power supply is started by the start of power supply and of monitoring the reaching of each non-power-supply time zone, (d) a step of stopping power supply using the corresponding connector when it is judged by the monitoring of the reaching of the non-power-supply time zone that any one of the non-power-supply time zones is reached, (e) a step of sequentially comparing the time data with the corresponding time zone data in the time zone data storage section, for each connector, power supply to which is stopped by the power supply stop, and of monitoring the end of each non-power-supply time zone, and (f) a step of resuming power supply using the corresponding connector when it is judged by the non-power-supply time zone end monitoring that any one of the non-power-supply time zones is ended.

In the fourth aspect of the present invention, when a communication apparatus to which power is to be supplied is newly connected to one or any one of the a plurality of connectors, each provided with a plurality of connection terminals and part or all of the connection terminals being power supply terminals for supplying power to communication apparatuses to be connected, this connection is detected. Then, power supply using the connector is started for the communication apparatus connected to the corresponding connection terminals. The time data output from the clock is sequentially compared with the corresponding time zone data in the time zone data indicating non-power-supply time zones each serving as a time zone during which respective power supply terminals should not perform power supply, the time zone being stored in the time zone data storage section in correspondence with each connector. By comparison, the reaching of each non-power-supply time zone is monitored sequentially. When it is judged that any one of the non-power-supply time zones is reached, power supply using the corresponding connector is stopped. Furthermore, the end of each non-power-supply time zone for the connector, power supply to which is stopped is sequentially monitored similarly. When it is judged that the end of the non-power-supply time zone is reached, power supply using the corresponding connector is resumed. Hence, it is possible to prevent power from being supplied to an apparatus to which power is not to be supplied. Furthermore, power supply to the connected communication apparatuses to which power is to be supplied can be started and stopped according to a predetermined schedule, without intermittently supplying power to the communication apparatuses. Power saving can thus be realized.

As described above, in the present invention, a judgment is made as to whether a communication terminal connected to a connector, part or all of the connection terminals of which are power supply terminals, is in a state of requiring power supply or not, according to time data and time zone data indicating non-power-supply time zones, or according to the detection of the frequency in which power supply is required and the time threshold value. Then, power supply using the corresponding connector is stopped as necessary. Hence, unnecessary power supply can be reduced, and power saving can be realized. Still further, since this effect is obtained by ingeniously designing only the apparatus on the power supply side, in the case that there are numerous communication terminals to be connected, the cost of the entire communication system can be reduced when power saving is realized.

### BRIEF DESCRIPTION OF THE DRAWINGS

FIG. 1 is a view showing the general configuration of a communication system wherein a layer 2 switch in accordance with an embodiment of the present invention is used;

FIG. 2 is a view showing the configuration of the layer 2 switch in accordance with the embodiment;

FIG. 3 is a flowchart showing the flow of power supply possible/impossible judgment processing using a power supply possible/impossible judgment section in accordance with the embodiment;

FIG. 4 is a schematic view showing table contents stored in a scheduling section of the embodiment;

FIG. 5 is a view showing the configuration of a layer 2 switch of a first modification example of the present invention;

FIG. 6 is a flowchart showing the flow of power supply possible/impossible judgment processing using a power supply possible/impossible judgment section of the first modification example;

FIG. 7 is a flowchart showing the flow of power supply stop shift processing using the power supply possible/impossible judgment section of the first modification example;

FIG. 8 is a schematic view showing table contents stored in a scheduling section of the first modification example;

FIG. 9 is a view showing the configuration of a layer 2 switch of a second modification example of the present invention;

FIG. 10 is a flowchart showing the flow of power supply possible/impossible judgment processing using a power supply possible/ixmpossible judgment section of the second modification example;

FIG. 11 is a flowchart showing the flow of power supply resumption judgment processing using the power supply possible/impossible judgment section of the second modification example; and

FIG. 12 is a schematic view showing table contents stored in a scheduling section of the second modification example.

### THE PREFERRED EMBODIMENTS OF THE INVENTION

Preferred embodiments in accordance with the present invention will be described below specifically referring to the accompanying drawings.

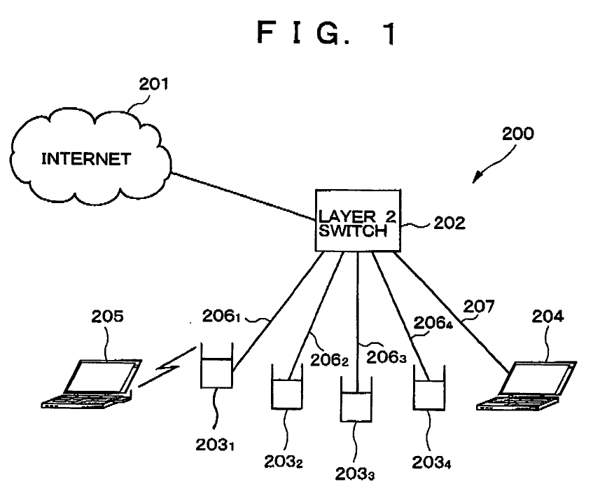

FIG. 1 is a general view of a communication system wherein a layer 2 switch is used as a power supply control apparatus in accordance with a first embodiment of the present invention. This communication system 200 is configured so that first to fourth access points 203₁ to 203₄ serving as wireless LAN access points are connected to the Internet 201 via a layer 2 switch 202 that judges the destination of transfer according to the data link layer and carries out packet transfer. A maintenance terminal 204 for performing maintenance and various settings for the layer 2 switch 202 is further connected to the layer 2 switch 202. Furthermore, in the communication area of the first access point 203₁, a wireless LAN terminal 205 is present. The first to fourth access points 203, to 203₄ are connected to the layer 2 switch 202 via first to fourth communication cables 206₁ to 206₄, respectively. The maintenance terminal 204 is connected to the layer 2 switch 202 via a maintenance communication cable 207.

The layer 2 switch 202 and the first to fourth access points 203₁ to 203₄ are disposed by an Internet provider. It is assumed that the first to fourth access points 203₁ to 203₄ are disposed, for example, in an office, a tea corner, a carrying-in entrance and the sales floor of a supermarket, respectively. The circumference of each access point 203 is a communication area wherein wireless transmission and reception are possible. A user who has completed his user registration brings his wireless LAN terminal 205 into any one of the communication areas and connects the terminal to the access point 203 in the communication area, whereby the user can access the Internet 201. The information management server (not shown) of the head office for controlling a plurality of supermarkets including the above-mentioned supermarket is connected to the Internet 201 at all times. Hence, information communication with the head office can be performed by connecting the wireless LAN terminal 205 to the Internet 201. In addition, the layer 2 switch 202 is a power supplying apparatus conforming to the IEEE (the Institute of Electrical and Electronic Engineers) 802.3af standard, and the first to fourth access points 203₁ to 203₄ are power receiving apparatuses also conforming to the same standard. In other words, these are the so-called PoE compatible apparatuses. The layer 2 switch 202 is intended to supply power to the first to fourth access points 203₁ to 203₄ via the first to fourth communication cables 206₁ to 206₄, respectively. Both the wireless LAN communication terminal 205 and the maintenance terminal 204 are each provided with a CPU (central processing unit) and a storage medium, these are not shown, and perform control for predetermined communication and maintenance using control programs stored in the storage medium.

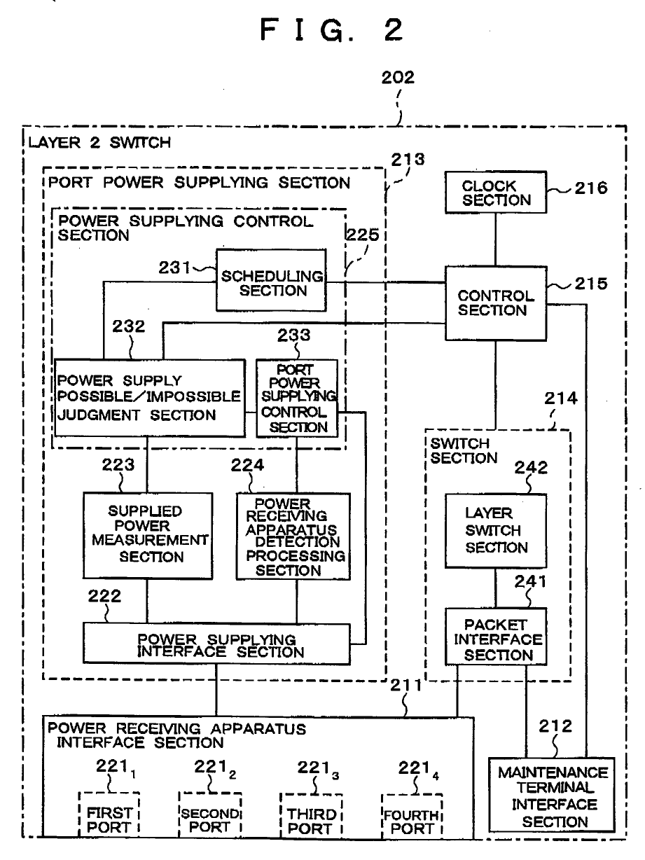

FIG. 2 shows the configuration of the layer 2 switch 202. The layer 2 switch 202 is provided with a power receiving apparatus interface section 211 for connecting the first to fourth access points 203₁ to 203₄ serving as power receiving apparatuses, and a maintenance terminal interface section 212 for connecting the maintenance terminal 204. In addition, to the power receiving apparatus interface section 211, a port power supplying section 213 is connected for supplying power to each access point 203 via the power receiving apparatus interface section 211, and a switch section 214 for transmitting/receiving data to/from each access point 203. Furthermore, a control section 215, connected to the port power supplying section 213, the switch section 214 and the maintenance terminal interface section 212, for changing the various settings and monitoring the states of the respective sections is provided. A clock section 216 for sequentially outputting time data is further connected to the control section 215. Moreover, the switch section 214 is also connected to the maintenance terminal interface section 212 to transmit/receive data to/from the maintenance terminal 204.

The power receiving apparatus interface section 211 is provided with first to fourth ports 221₁ to 221₄, to which the first to fourth communication cables 206, to 2064 shown in FIG. 1 are connected, respectively. The port power supplying section 213 is provided with a power supplying interface section 222, connected to the power receiving apparatus interface section 211 to which power is supplied from a local power source, not shown, for supplying power to each access point 203 via the power receiving apparatus interface section 211. Furthermore, the port power supplying section 213 is provided with a supplied power measurement section 223 for sequentially measuring power supplied from the first to fourth ports 221₁ to 221₄ from the power supplying interface section 222 and a power receiving apparatus detection processing section 224 for detecting power receiving apparatuses connected to the first to fourth ports 221₁ to 221₄. Still further, the port power supplying section 213 is provided with a power supplying control section 225 for controlling power supply from the first to fourth ports 221₁ to 221₄.

The power supplying control section 225 is provided with a scheduling section 231 for scheduling power supply, a power supply possible/impossible judgment section 232 for judging whether power supply is performed for each port 221 on the basis of the scheduling or not, and a port power supplying control section 233 for controlling power supply for each port 221 according to the judgment. The scheduling section 231 and the power supply possible/impossible judgment section 232 are connected to the control section 215.

The switch section 214 is provided with a packet interface section 241, connected to the power receiving apparatus interface section 211 and the maintenance terminal interface section 212, for performing packet transfer. Furthermore, the switch section 214 is provided with a layer switch section 242, connected to the packet interface section 241 and the control section 215, for performing packet switching at the data link layer between the Internet 201 and the first to fourth ports 221, to 2214 or the maintenance terminal 204. The layer 2 switch 202 is provided with a port, connected to the switch section 214, for connection to the Internet 201 shown in FIG. 1. However, since this port does not relate to power supply to each access point 203, the port is not shown and its description is omitted.

The various sections of the layer 2 switch 202 are realized using a CPU, a storage medium, such as a RON (read-only memory) in which control programs are stored, and circuit components serving as existing hardware, these are not shown. More specifically, for example, the supplied power measurement section 223 and the power receiving apparatus detection processing section 224 are realized using an amplifier circuit including an operational amplifier, and the power supplying interface section 222 is realized using a switching circuit formed of an FET (field effect transistor). In addition, the power supplying control section 225 is provided with an A/D converter for converting an analog signal received from the supplied power measurement section 223 into a digital signal. Furthermore, the packet interface section 241 is formed of an Ethernet (registered trademark) PHY-LSI (PHYsical sublayer—Large Scale Integrated circuit), and the layer switch section 242 is formed of an Ethernet (registered trademark) switch LSI. Moreover, power from the local power source (not shown) of the layer 2 switch 202 is supplied to the power supplying interface section 222, and the power is converted into a direct current of up to 15. 4 watts at 48 volts and is sent to the power receiving apparatus interface section 211.

The first to fourth communication cables 206₁ to 206₄ shown in FIG. 1 are cables conforming to the Category 5e UTP (Unshielded Twisted Pair) cables standardized by the Electronic Industries Alliance (EIA), for example, and are each equipped with an RJ45 (Registered Jack 45) connector standardized by Bell Laboratories at the end thereof. In addition, the first to fourth ports 221₁ to 221₄ of the power receiving apparatus interface section 211 are also each equipped with an RJ45 connector. On the other hand, the maintenance communication cable 207 is an RS232C serial cable conforming to RS232C, a serial transmission system standard specified by the EIA, and is equipped with a D-sub connector conforming to the standard at the end thereof. Furthermore, the maintenance terminal interface section 212 also has a D-sub connector and is equipped with a transceiver IC (Integrated Circuit).

In the IEEE 802.3af standard, one pair among the four pairs of copper wires of the UTP cable and the RJ45 connector is used as a positive electrode and another pair thereof is used as a negative electrode, and power is supplied from a power supplying apparatus to a power receiving apparatus. The RJ45 connector is an 8-pin modular connector used in conformity with the 10BASE-T standard as a port having a transmission speed of 10 Mbps or in conformity with the 100BASE-TX standard as a port having a transmission speed of 100 Mbps. The reason why the two pairs are used for power supply is that two types of UTP cables are available conventionally: one type with two pairs of wires and the other type with four pairs of wires. In the case of the UTP cable with two pairs of wires, the same copper wires as those used for data communication are used for power supply. However, in the case of the UTP cable with four pairs of wires, the two pairs of copper wires other than the two pairs of wires used for data communication can also be used for power supply.

Furthermore, the maintenance terminal 204 is intended to access the control section 215 using communication protocols, such as the VT100 emulation, Telnet and SNMP (Simple Network Management Protocol), The change of the settings of the respective sections, the monitoring of the states of the respective sections and the transmission of information to the maintenance terminal 204 can be instructed to the control section 215 by the operation of the maintenance terminal 204.

Processing in the case that power is supplied to the first to fourth access points 203₁ to 203₄ using the layer 2 switch 202 configured as described above will be described below. The power supply possible/impossible judgment section 232 of the layer 2 switch 202 judges whether power supply for each port 221 is possible or not, and sequentially transmits the result of the judgment to the port power supplying control section 233, thereby performing power supplying control for each port 221. Herein, the control of power supply to the first access point 203₁ in the case that the first access point 203₁ shown in FIG. 1 is newly connected to the layer 2 switch 202 and that the wireless LAN terminal 205 accesses the Internet 201 via the first access point 203₁, is taken as an example and is described below.

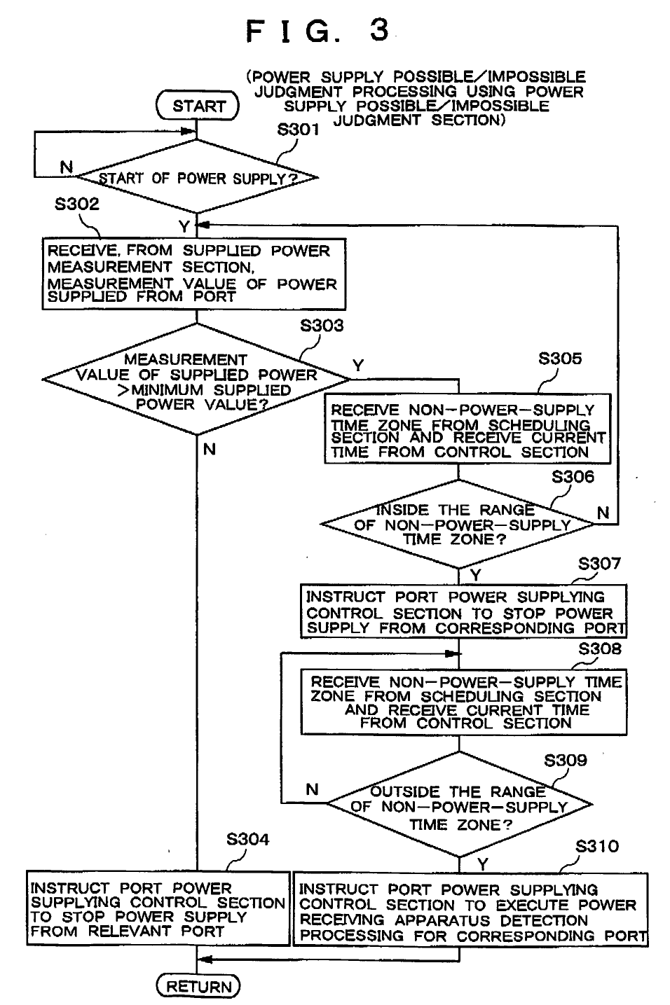

FIG. 3 shows the flow of the power supply possible/impossible judgment processing using the power supply possible/impossible judgment section of the layer 2 switch. The power receiving apparatus detection section 224 judges whether a communication apparatus is connected to each port 221 or not, judges whether the communication apparatus connected thereto is a power receiving apparatus to which power can be supplied or not, and judges how much maximum power is supplied to the power receiving apparatus. In other words, the power receiving apparatus detection section 224 carries out the power receiving apparatus detection processing for the power receiving apparatus. More specifically, the port power supplying section 213 is equipped with a table (hereinafter referred to as a power supply possible/impossible table, not shown) describing the power supply possibility/impossibility for each port 221. To the power supplying interface section 222, the power receiving apparatus detection processing section 224 periodically applies a pulse voltage in the range of 2.8 to 10 volts to each port 221 that is registered to be “power supply impossible” in the power supply possible/impossible table. When a communication apparatus is connected to any one of the ports 221, the value of the current flowing therethrough changes depending on the resistance value thereof. Hence, according to the value of the current, a judgment is made as to whether the communication apparatus is a power receiving apparatus or not, and the correspondence to the value of the current is made beforehand so that the maximum supplied power is specified.

More specifically, in a power receiving apparatus conforming to the PoE, it is determined that the circuit to be connected to the power supply terminal is provided with a detection resistor of 25 kiloohms. Currents obtained respectively when pulse voltages having two different voltage values are applied thereto are detected. When it is confirmed according to the two pairs of voltage values and current values that a resistor of 25 kiloohms is provided in the connected communication apparatus, it is judged that a power receiving apparatus conforming to the PoE is connected. When it is judged that a power receiving apparatus conforming to the PoE is connected, a pulse voltage having a higher voltage value is then applied, and the power class of the power receiving apparatus is judged. The power class is obtained by classifying power depending on the magnitude of the power required to be supplied. The current value and the maximum supplied power value for each power class, serving as criteria for power classification, are stored in the power receiving apparatus detection processing section 224 beforehand while having correspondence therebetween, not shown. Hence, the maximum supplied power value can be specified by retrieving the values.

Herein, since the first access point 203₁ serving as a power receiving apparatus is connected to the first port 221₁ via the first communication cable 206₁, the fact that the power receiving apparatus detection processing at the first port 221 has been performed successfully is notified to the port power supplying control section 233. Furthermore, the content in the above-mentioned power supply possible/impossible table (not shown), described with respect to the first port 221₁, is rewritten to “power supply possible.” When the port power supplying control section 233 is notified from the power receiving apparatus detection processing section 224 that the power receiving apparatus detection processing for the first access point 203₁, that is, for the power receiving apparatus connected to the first port 221₁, has been performed successfully, the port power supplying control section 233 instructs the power supplying interface section 222 to start power supply from the first port 221 (power supply is turned on). In the case of this power supply, power required at the first access point 203₁ is supplied, the power being within the range of the maximum supplied power value specified in the power receiving apparatus detection processing and within the power capable of being supplied from the layer 2 switch 202. The port power supplying control section 233 notifies to the power supply possible/impossible judgment section 232 that power supply has started from the first port 222₁.

When the power supply possible/impossible judgment section 232 is notified from the port power supplying control section 233 that power supply has started from the first port 222₁ as described above (Y at step S301), the power supply possible/impossible judgment section 232 starts processing for sequentially making a judgment using the scheduling section 231 as to whether power supply from the first port 2221 should be stopped or not. First, the value of the power supplied from the first port 221₁ is measured (at step S302). More specifically, the supplied power measurement section 223 monitors the currents supplied and the voltages applied from the first to fourth ports 221₁ to 221₄ at the power supplying interface section 222 and outputs analog signals. These output analog signals are converted into digital signals by the A/D converter (not shown) of the power supplying control section 225. The power supply possible/impossible judgment section 232 obtains the digital signals as current and voltage measurement values. These values are multiplied to obtain the measurement value of the supplied power.

The power supply possible/impossible judgment section 232 sequentially monitors whether the first access point 203₁ is in a state of being connected to the first port 221₁ or not, by comparing the value of power supplied from the first port 221₁ with a preset minimum supplied power value. The minimum supplied power value is a power value that is assumed to be supplied steadily when a power receiving apparatus is connected to the port 221 and is consumed as standby power for performing reception at the receiving apparatus. The minimum supplied power value can be set unanimously at the same value or can be set individually at different values for the first to fourth ports 221₁ to 221₄ using the maintenance terminal 204. However, the minimum supplied power value is set so as to be lower than the standby power of the receiving apparatus to be connected, in consideration of the resistance and the like of each communication cable 206. It is herein assumed that the minimum supplied power value of the first port 221₁ is set at 2 watts. In the case that the measurement value of the power supplied from the first port 221₁ is 2 watts or less (N at step S303), it is judged that the connection at the first port 221₁ is disconnected, and the port power supplying control section 233 is instructed to stop power supply from the first port 221₁ (at step S304). The processing ends and the system stands by for the resumption of power supply from the first port 221₁ (return).

The port power supplying control section 233 stops power supply from the first port 221₁ according to the instruction at step S304 (power supply is turned off), and this stop is notified to the power supply possible/impossible judgment section 232. A power receiving apparatus, the power supply to which has been stopped, cannot perform communication. Hence, the apparatus is not only in the same state as that of being disconnected but also in a state of being not detected even if the apparatus is physically disconnected while power supply thereto is stopped. Hence, the port power supplying control section 233 renews the content for the first port 221, in the above-mentioned power supply possible/impossible table (not shown) to “power supply impossible.” Hereinafter, similarly, each time power supply is stopped, the content for the corresponding port 221 in the power supply possible/impossible table is renewed to “power supply impossible.” Since the power receiving apparatus detection processing section 224 carries out power receiving apparatus detection processing for the port 221 being registered to be “power supply impossible” in the power supply possible/impossible table, when a power receiving apparatus is newly connected, this apparatus is detected, and the processing is repeated.

On the other hand, in the case that the measurement value of the power supplied from the first port 221₁, received at step S303₁ is larger than the minimum supplied power value (Y at step S303), it is judged that the first access point 203₁ is in a state of having been connected continuously to the first port 221₁. Next, a non-power-supply time zone, a time zone during which power supply from the first port 221₁ is stopped, is transmitted to the scheduling section 231, and the newest time data, that is, the current time output from the clock section 216₁ is transmitted to the control section 215 (at step S305).

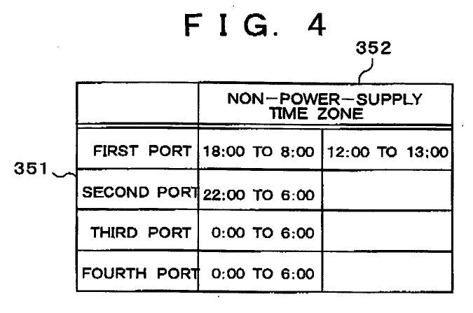

FIG. 4 is a table indicating contents stored in the table stored in the scheduling section 231. In a table 351 stored in the storage area (not shown) of the scheduling section 231, a non-power-supply time zone 352 is described for each port 221. For example, time zones “18:00 to 8:00” and “12:00 to 13:00” are described for the first port 221₁, and time zone “22:00 to 6:00” is described for the second port 221₂. These in the non-power-supply time zone 352 are time zones during which the estimated frequency of using each access point 203 for communication is relatively low or during which the access point 203 is not used at all or during which it is determined that the access point 203 is not used.

The first access point 203₁ is disposed in an office as described above. The working hours of the office workers in the office are 8:00 to 18:00, excluding lunch break 12:00 to 13:00. Hence, power supply to the first access point 203₁ is required only during two time zones, that is, 8:00 to 12:00 and 13:00 to 18:00. For the purpose of saving power, it is desirable that power supply should be stopped in the time zones other than the two time zones. If the user of the wireless LAN terminal 205 manually disconnects the connection of the first access point 203₁ to the layer 2 switch 202 each time the current time becomes close to 12:00 and 18:00, power supply to the first access point 203₁ is stopped. However, this manual disconnection is troublesome for the user and may be neglected by the user in some cases, thereby being uncertain. Furthermore, in the case that the first access point 203₁ is installed at a place where it is difficult to reach by hand, such as a place near the ceiling, manual disconnection is difficult. Hence, in the layer 2 switch 202, it is made possible that the table 351 is preset by the operation of the maintenance terminal 204 and that power supply from each port 221 is controlled dynamically by the layer 2 switch 202 using the table 351.

The description is continued, returning to FIG. 3. After the non-power-supply time zone and the current time are received at step S305, a judgment is then made as to whether the current time is in the non-power-supply time zone 352, that is, in the time zone during which power supply should be stopped. In the case that the current time received at step S305 is not in the non-power-supply time zone 352 received at step S305 (N at step S306), the processing returns to step S302. Then, port connection is confirmed. In the case that port connection is performed, the current time is confirmed again. In this way, once power supply is started, the processing from step S302 to step S306 is repeated unless the port 221 is disconnected during time zones other than the non-power-supply time zone 352. For example, in the case that power is supplied from the first port 221, and the current time is 11:00, the current time is not in the non-power-supply time zone 352. Hence, the processing returns from step S306 to step S302.

However, when the time passes and becomes 12:01, for example, the time received at step S305 also becomes 12:01 and is inside the range of the non-power-supply time zone 352 (Y at step S306). Hence, the port power supplying control section 233 is instructed to stop power supply from the first port 221, (at step S307). However, since the stopping of the power supply is not instructed by the first access point 203, or the first port 221₁ is not disconnected, power supply is required to be started again after the end of the non-power-supply time zone 352. Hence, the non-power-supply time zone 352 is transmitted again to the scheduling section 231, and the current time is also transmitted to the control section 215 (at step S308). Then, a judgment is made as to whether the received time is inside the range of the non-power-supply time zone 352 or not (at step S309). In the case that the received time is inside the range of the non-power-supply time zone 352 (N at step S309), the processing returns to step S308, and time measurement is repeated. In the case that the current time is 12:30, for example, the time is inside the range of the non-power-supply time zone 352. Hence, the processing returns from step S309 to step S308.

When the time passes and becomes 13:01, for example, the time received at step S308 also becomes 13:01 and is outside the range of the non-power-supply time zone 352 (Y at step S309). Hence, power supply should be started again from the first port 221₁. However, there is a possibility that the communication cable is removed or the communication apparatus is replaced with another communication apparatus while power supply is stopped. Hence, the port power supplying control section 233 is instructed that the power receiving apparatus detection processing section 224 carries out power receiving apparatus detection processing again (at step S310). Then, the processing ends, and the system stands by for the notification of the restart of power supply (return). After power supply is stopped at step S307, it is desirable that power supply is not started each time the connection of a new power receiving apparatus is detected, until the corresponding non-power-supply time zone 352 ends. Hence, at step S307 wherein power supply is stopped because the non-power-supply time zone 352 is reached, the corresponding content in the above-mentioned power supply possible/impossible table (not shown) is not renewed immediately to “power supply impossible.” This renewal is done after the non-power-supply time zone 352 ends. This renewal corresponds to step S310, and the power receiving apparatus detection processing section 224 is indirectly instructed to perform the power receiving apparatus detection processing. Hence, wasteful pulse voltage application from the power receiving apparatus detection processing section 224 can be suppressed.

In consideration of the case that the contents in the table 351 are changed in mid-process, the non-power-supply time zone 352 is received at step S305 and step S308. However, in the case that the frequency of the change is low, these steps can be omitted, and a step of receiving the non-power-supply time zone 352 may be inserted before step S302. Furthermore, the cycle in which the processing from step S306 to step S302 is repeated and the cycle in which the processing from step S308 to step S309 is repeated may be set beforehand, or the contents of the settings may be made changeable using the maintenance terminal 204. In the case that the start and stop of power supply are desired to be performed at more precise timing, the time intervals should only be set shorter. In the case that the burden on the apparatus is desired to be reduced regardless of the timing, the time intervals should only be set longer.

As described above, in this embodiment, the layer 2 switch 202 is equipped with the table 315 describing the non-power-supply time zone 352 as a time zone during which power supply to a power receiving apparatus connected to each port 221 is not performed and is also equipped with the clock section 216 for outputting time data. The current time is sequentially compared with the non-power-supply time zone 352 corresponding to each port 221. If the current time is outside the range of the non-power-supply time zone 352, power supply is continued or power supply being stopped is resumed. If the current time is inside the range of the non-power-supply time zone 352, power supply is stopped. Hence, power saving can be attained by ingeniously designing only the layer 2 switch 202 side serving as a power supplying apparatus. In addition, power saving can be realized without particularly adversely affecting communication by setting the non-power-supply time zone 352 at a time zone during which communication is not performed using the power receiving apparatus connected to each port 221 or at a time zone during which the frequency of communication using the power receiving apparatus connected is low. Furthermore, once the contents in the table 351 of the scheduling section 231 are set, power supply can be controlled properly and continuously, provided that the connection relationship among communication apparatuses or the usage state of each power receiving apparatus is not changed. Hence, it is possible to reduce the user's time and effort in disconnecting the connection of each power receiving apparatus and the communication system manager's time and effort in sequentially setting the possibility/impossibility of power supply for each apparatus via the maintenance terminal. Moreover, the actual measurement value of the supplied power being set at each port 221 is compared with the minimum supplied power value. In the case that the measurement value is lower than the minimum supplied power value, power supply is stopped. Hence, in the case that the communication cable 206 or the access point 203 is removed from the port 221 unexpectedly or intentionally while power is supplied, this removal can be detected, and the system can stand by for the connection of a new power receiving apparatus.

In the embodiment described above, when the non-power-supply time zone is reached, power supply from the layer 2 switch 202 is stopped regardless of the usage state of the access point to which an apparatus is connected. However, if the communication being continued at the time when the non-power-supply time zone is reached is stopped in mid-process, a problem may occur. To solve this problem, a layer 2 switch for controlling power supply in consideration of this case will be described below as a first modification example.

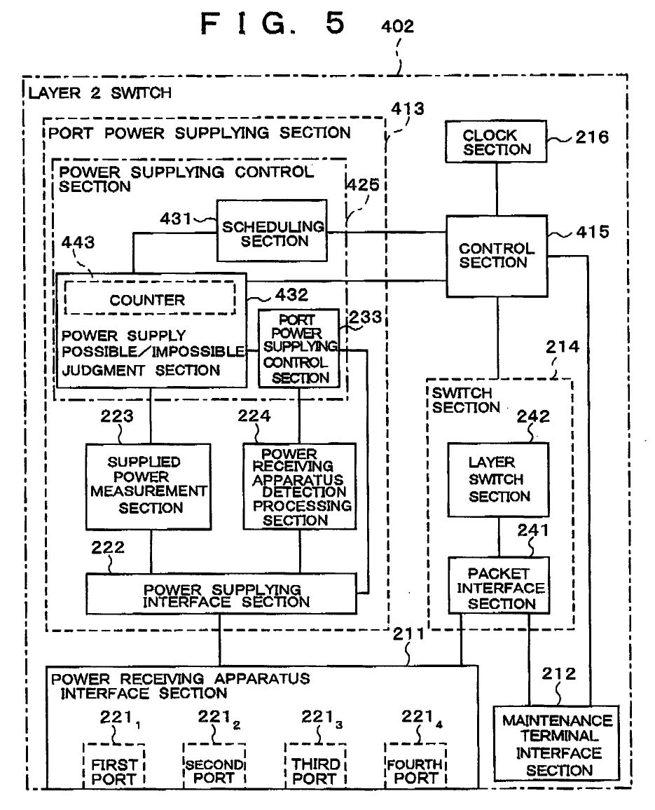

FIG. 5 shows the configuration of the layer 2 switch of the first modification example, corresponding to FIG. 2 in the embodiment. The same components as those shown in FIG. 2 are designated by the same numerals, and their descriptions are omitted as appropriate. In a layer 2 switch 402, a scheduling section 431 for storing a table different from that shown in FIG. 4 and a power supply possible/impossible judgment section 432 for performing processing different from that shown in FIG. 3 are provided instead of the scheduling section 231 and the power supply possible/impossible judgment section 232 of the power supplying control section 223 shown in FIG. 2. In correspondence with this, the power supplying control section 225 and the port power supplying section 213 are replaced with a power supplying control section 425 and a port power supplying section 413, respectively. In addition, a control section 415 is provided instead of the control section 215 shown in FIG. 2. Furthermore, the power supply possible/impossible judgment section 432 is newly provided with a counter 443 for use in the judgment as to whether communication using each port 221 is being performed or not. The counter 443 is capable of counting elapsed time for each port 221.

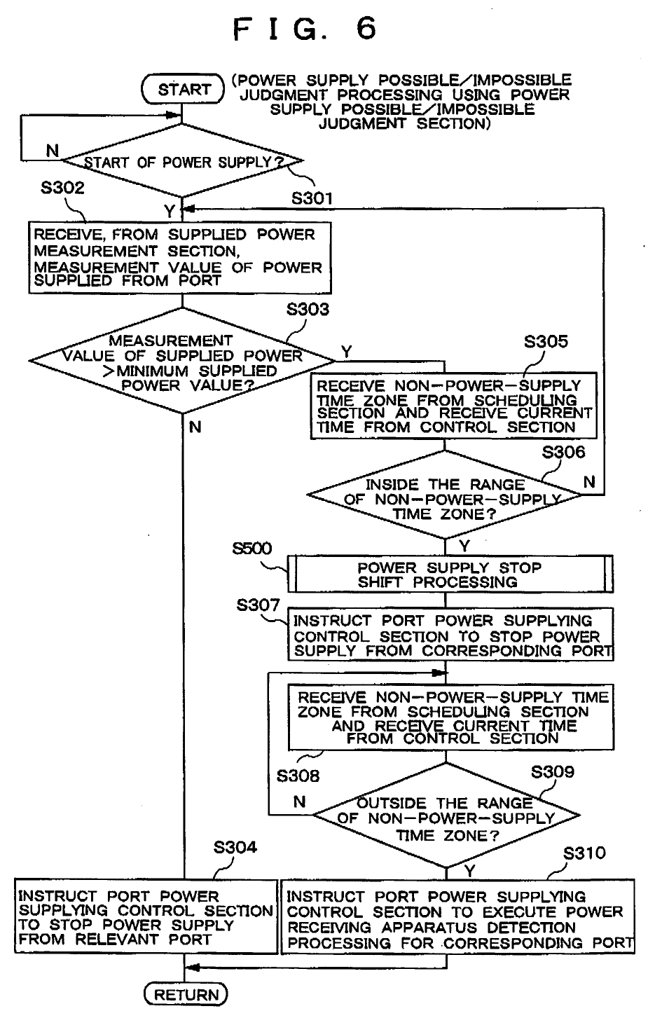

FIG. 6 shows the flow of the power supply possible/impossible judgment processing using the power supply possible/impossible judgment section, corresponding to FIG. 3 in the embodiment. The same steps as those shown in FIG. 2 are designated by the same numerals, and their descriptions are omitted as appropriate. The power supply possible/impossible judgment section 432 carries out processing similar to that shown in FIG. 3 at steps up to step S306 and at step S307 and the following steps. However, if it is judged that the current time is inside the range of the non-power-supply time zone 352 at step S306 (Y), power supply stop shift processing shown at step S500 is executed before step S307.

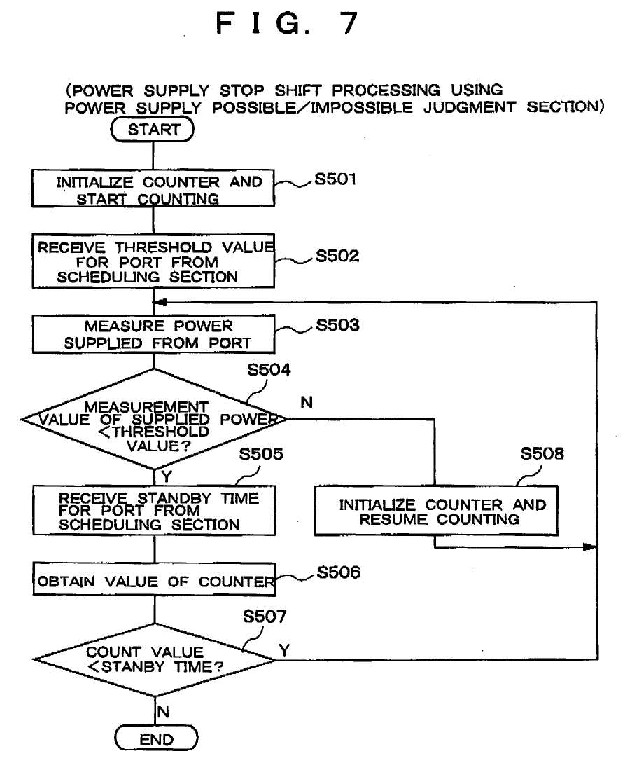

FIG. 7 shows the flow of the power supply stop shift processing executed using the power supply possible/impossible judgment section, corresponding to step S500 shown in FIG. 6. In the case that the power supply possible/impossible judgment section 432 judges that the current time is inside the range of the non-power-supply time zone 352 at step S306 shown in FIG. 6, the judgment section first judges whether the first access point 203, connected to the first port 221₁ is used for communication or not, using the table provided in the scheduling section 431.

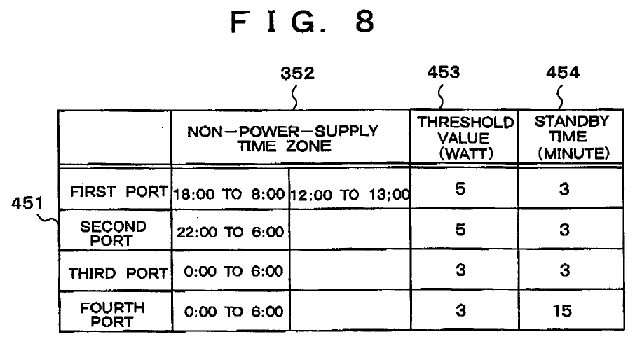

FIG. 8 shows a table contents stored in the scheduling section, corresponding to the table shown in FIG. 4 in the embodiment. The same items as those shown in FIG. 4 are provided with the same titles, and their descriptions are omitted as appropriate. In the table 451 provided in the scheduling section 431, the threshold value 453 of power being used as the criterion depending on which judgment as to whether communication is being performed or not for each port is described in watts, in addition to the non-power-supply time zone 352. Furthermore, standby time 454 from the standby for the continuation of the state of non-communication to the stop of power supply is described in minutes. Like the contents in the table 351 shown in FIG. 4, the contents in the table 451 can be set and changed via the control section 415 by the operation of the maintenance terminal 204. Since the threshold value 453 is determined to be an inherent value for each communication apparatus in some cases, such information may be obtained by information exchange with the communication apparatus during the power receiving apparatus detection processing using the power receiving apparatus detection processing section 224, and the threshold value 453 may be set on the basis of the obtained information.

In this table, for example, 5 watts is described as the threshold value 453 and 3 minutes is described as the standby time 454 for the first port 221₁. These indicate that communication is performed in the case that the measurement value of the power supplied from the first port 221₁ is 5 watts or more and that communication is not performed continuously in the case that it is judged that communication is not performed for 3 minutes or more. The state that communication is not performed continuously means a state wherein no trouble occurs even if the first access point 203₁ is not in operation, because, for example, the user of the wireless LAN terminal 205 has left his seat during a lunch break or is performing an action other than communication.

The description is continued, returning to FIG. 7. The power supply possible/impossible judgment section 432 clears (initializes) the value of the counter 443 and starts counting (at step S501) to measure the time period from the reaching of the non-power-supply time zone 352 to the continuation of non-communication. In addition, the scheduling section 431 is instructed to transmit the threshold value 453 for the first port 221, (at step S502). Then, the measurement value of the power supplied from the first port 221₁ is transmitted to the supplied power measurement section 223 (at step S503). The measurement value is compared with the threshold value 453 received at step S502 (at step S504). In the case that the measurement value of the supplied power is smaller than the threshold value 453 (Y), it is judged that communication using the first access point 203₁ is not being performed, and the processing is shifted to a judgment as to whether the state is a state wherein no trouble occurs even if power supply to the first access point 203₁ is stopped.

The power supply possible/impossible judgment section 432 instructs the scheduling section 431 to transmit the standby time 454 for the first port 221, (at step S505), obtains the value of the counter 443 (at step S506) and compares the standby time with the counter value (at step S507). Since the value of the counter 443 indicates the time elapsed from the reaching of the non-power-supply time zone 352 to the continuation of non-communication, in the case that the measurement value does not reach the standby time 454 (Y), the processing returns to step S503, and the measurement value of the power supplied from the first port 221₁ is monitored again. While the processing from step S503 to step S507 is repeated, time passes, and the measurement value of the supplied power received at step S503 and the value of the counter 443 measured at step S506 are changed.

In the case that the measurement value of the power supplied from the first port 221₁ received at step S503 is 4 watts, for example, since 4 watts is smaller than 5 watts serving as the threshold value 453 received at step S502, the processing proceeds to step S505. Furthermore, in the case that the time from the reaching of the non-power-supply time zone 352 to the continuation of non-communication is only 1 minute when the processing is shifted further to step S506, the measurement value at step S506 is 1 minute. Since 1 minute is less than 3 minutes serving as the standby time 454 received at step S505, the processing returns to step S503. Then, in the case that the value of the counter 443 has reached 3 minutes (N at step S507) while the processing from step S503 to step S507 is repeated in a similar way, it is judged that the state is a state wherein no trouble occurs even if the first access point 203₁ is not in operation. Hence, the shift processing ends and the judgment processing proceeds to step S307 shown in FIG. 6. The port power supplying control section 233 is instructed to stop power supply from the first port 221₁.

On the other hand, in the case that communication is being performed even after the judgment processing is shifted to the power supply stop shift processing, the measurement value of the power supplied from the first port 221₁ becomes the threshold value 453 or more (N at step S504). The power supply possible/impossible judgment section 432 stops and initializes the counter 443, and the counting is resumed (at step S508), and the shift processing returns to step S503. Hence, the time period during which communication is not performed is reset. In other words, in the case that communication is resumed before the time period during which communication is not performed reaches the standby time 454 being set for the port 221, the operation state of the first access point 203₁ can be maintained.

In consideration of the case that the contents in the table 451 are changed in mid-process, it is assumed that the standby time 454 is received at step S505 between step S503 and step S507. However, in the case that the frequency of the change is low, the receiving of the standby time 454 may be performed before step S503. In addition, in consideration of the case that communication is continued all the while in the non-power-supply time zone, it may be possible that processing for judging whether the non-power-supply time zone has ended or not during the period from step S503 to step S507 shown in FIG. 7 and that the processing returns to step S302 shown in FIG. 6 in the case that the non-power-supply time zone has ended.

As described above, in this modification example, when the current time enters the non-power-supply time zone 352, the measurement value of the power supplied from the corresponding port 221 is compared with the preset threshold value 453, whereby a judgment is made as to whether the access point 203 to which power is supplied from the port is used for communication or not. In addition, the duration time of the state, not being used for communication, after the current time has entered the non-power-supply time zone 352 is measured, and the duration time is compared with the preset standby time 454, whereby a judgment is made as to whether trouble occurs or not even if power supply is stopped. Only after it is judged that no trouble occurs, power supply is stopped. In other words, even if the current time is inside the range of the non-power-supply time zone 352 being set as a time zone during which power supply to the access point 203 should be stopped, in the case that the user continuously performs communication in a period extending to the non-power-supply time zone 352, power supply can be continued, and the communication can be prevented from being interrupted. Hence, power saving can be realized in a state of being compatible with the actual communication state of the user.

In the first modification example described above, when the current time reaches the non-power-supply time zone 352, according to the communication state of the corresponding port, power supply is stopped after a judgment is made that no trouble occurs even if power supply is stopped. On the other hand, it is conceivable that power saving is also attained by stopping power supply using only the state of communication as a criterion. This corresponds to, for example, a case wherein, in an exhibition site provided with a plurality of wireless LAN access points, communication is performed frequently using wireless LAN terminals in the morning, but the users of the communication are reduced as time passes in the afternoon. Hence, as a second modification example, a case wherein power supply is stopped depending on the communication state, without setting the non-power-supply time zone, will be described below.

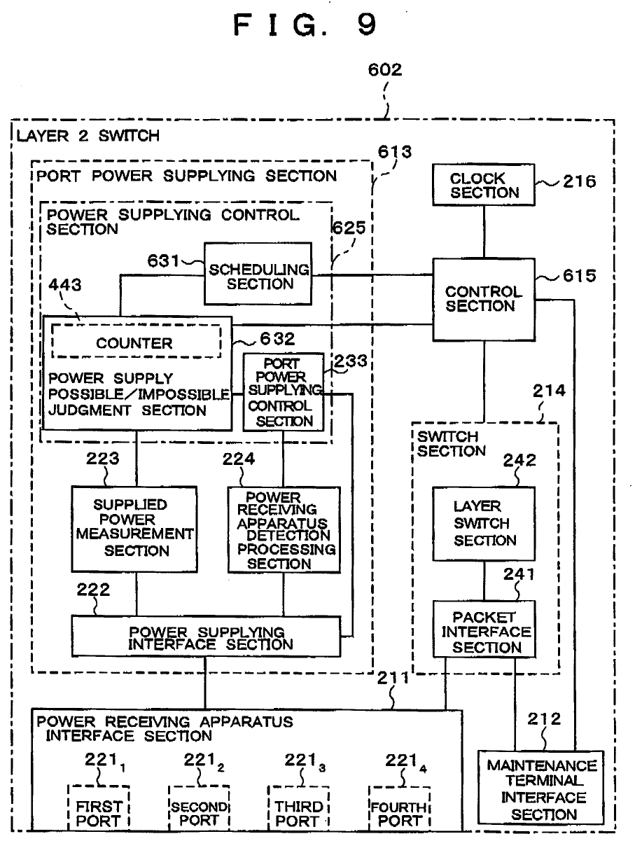

FIG. 9 shows the configuration of a layer 2 switch of the second modification example, corresponding to FIG. 5 in the first modification example. The same components as those shown in FIG. 5 are designated by the same numerals, and their descriptions are omitted as appropriate. In a layer 2 switch 602, a scheduling section 631 for storing a table different from that shown in FIG. 8 and a power supply possible/impossible judgment section 632 for performing processing different from that shown in FIG. 6 are provided instead of the scheduling section 431 and the power supply possible/impossible judgment section 432 of the power supplying control section 425 shown in FIG. 5. In correspondence with this, the power supplying control section 425 and the port power supplying section 413 are replaced with the power supplying control section 625 and the port power supplying section 613, respectively. In addition, a control section 615 is provided instead of the control section 415 shown in FIG. 5.

In this modification example, the first to fourth access points 203, to 2034 connected to the layer 2 switch 602, different from those in the embodiment and the first modification example, are disposed for the wireless LAN terminals 205 carried by individual visitors in an exhibition site. Furthermore, it is characterized in that the visitors in the exhibition site are concentrated in the time zone immediately after the opening and that the number of the visitors decreases as time passes. In other words, the whole communication frequency at the first to fourth access points 203, to 2034 decreases as time passes. For this reason, it is requested to stop power supply to some access points 203 which are not used frequently for communication, thereby attaining power saving. However, in the case that the number of visitors has increased temporarily, it is desirable that power supply to the access points 203, to which power supply was stopped once, is resumed so that the visitors can access the Internet 201 without inconvenience using the wireless LAN terminals 205. Hence, the state of communication is judged depending on the power supplied from each port 221, and power supply is controlled.

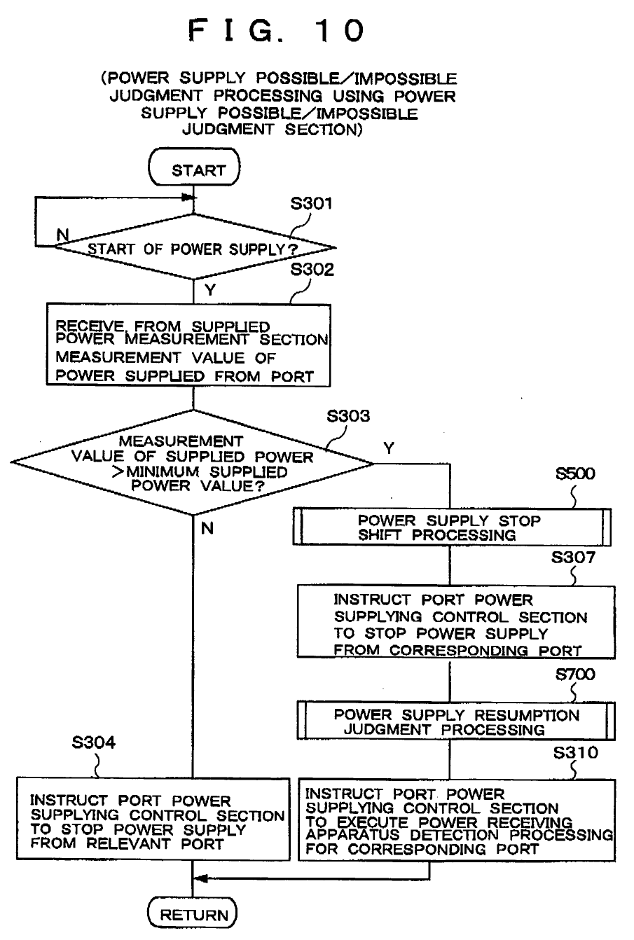

FIG. 10 shows the flow of the power supply possible/impossible judgment processing using the power supply possible/impossible judgment section, corresponding to FIG. 6 in the first modification example. The same steps as those shown in FIG. 6 are designated by the same numerals, and their descriptions are omitted as appropriate. The power supply possible/impossible judgment section 632 carries out processing similar to that shown in FIG. 6 at steps up to step S304. The processing from step S305 to step S306 is not performed, and the judgment processing proceeds to power supply stop shift processing at step S500 described in the first modification example. In other words, instead of processing wherein a non-power-supply time zone is set and power supply is stopped according to the non-power-supply time zone, the power supply stop shift processing is performed such that, in the case that communication is not performed only for a predetermined time, power supply from the corresponding port 221 is stopped regardless of the time zone. Furthermore, the power supply resumption judgment processing shown at step S700 is executed after the stopping of power supply from the port 221 is instructed at step S307, without performing the executing from step S308 to step S309.

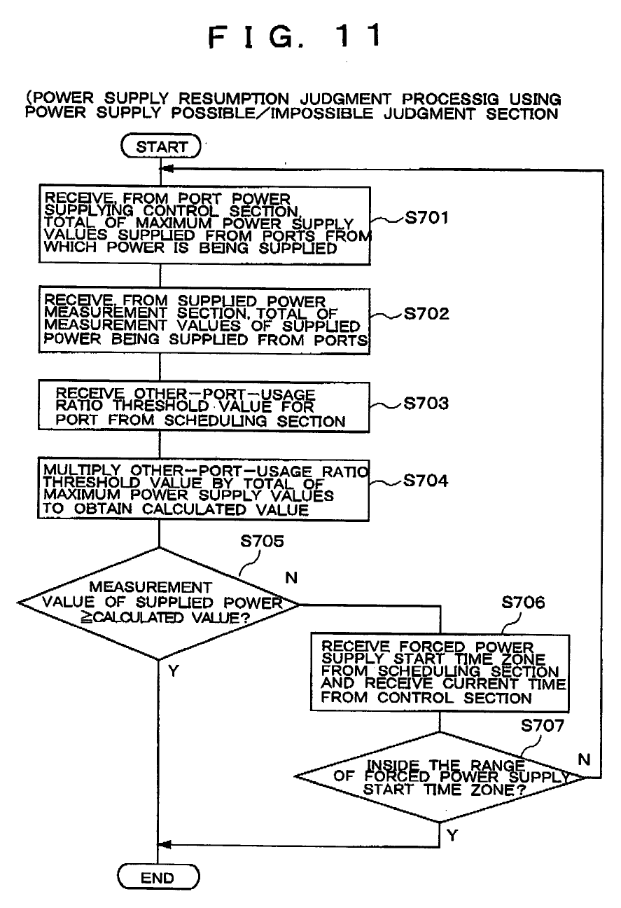

FIG. 11 shows the flow of the power supply resumption judgment processing executed using the power supply possible/impossible judgment section. After instructing the port power supplying control section 233 to stop power supply from the first port 221₁ at step S307 shown in FIG. 10, the power supply possible/impossible judgment section 632 requests the total of the maximum supplied power values supplied from the other ports 221 from which power is being supplied and then receives the total (at step S701). The maximum supplied power value is specified by the power receiving apparatus detection processing as described in the embodiment and is set as the maximum value of the power supplied from each port 221 by the power receiving apparatus detection processing. Power is herein being supplied from all the second to fourth ports 221₁ to 221₄, and the total of the maximum supplied power values being set respectively by the power receiving apparatus detection processing is received from the port power supplying control section 233. Instead of this, the maximum supplied power values for respective ports 221 may be received, and all of these may be added by the power supply possible/impossible judgment section 632.

In addition, the power supply possible/impossible judgment section 632 requests the supplied power measurement section 223 to output the total of the measurement values of power respectively supplied from the second to fourth ports 221₂ to 221₄ (at step S702). Then, from the scheduling section 631, the power supply possible/impossible judgment section 632 receives an other-port-usage ratio threshold value being used for making a judgment as to whether power supply from the first port 221₁ is resumed or not (at step S703).

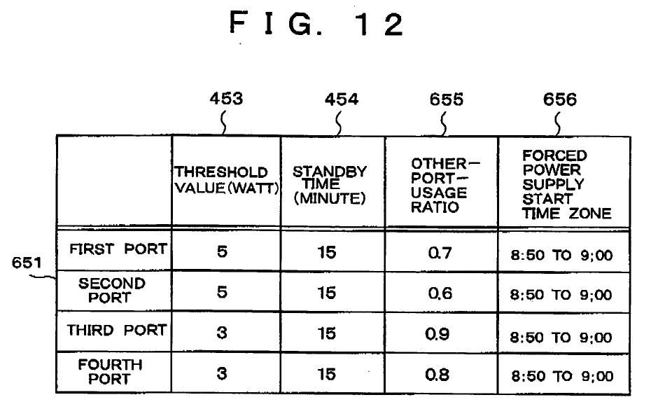

FIG. 12 shows table contents stored in the scheduling section, corresponding to the table shown in FIG. 8 in the first modification example. The same items as those shown in FIG. 8 are designated by the same titles, and their descriptions are omitted as appropriate. In the table 651 provided in the scheduling section 631, the threshold value 453 of power and the standby time 454 are described. However, unlike the table 451 shown in FIG. 8, no non-power-supply time zone is described. Furthermore, an other-port-usage ratio 655 used for making a judgment as to whether power supply is resumed or not and a forced power supply start time zone 656 being used as a time zone in which power supply is forcibly started in the case that power supply is stopped are described additionally.

The other-port-usage ratio 655 is used to indicate the basis of a judgment as to whether there is a possibility that trouble may occur in the communication of visitors in the case that only the ports 221 from which power is being supplied are used, depending on how much the ratio of the power being supplied from all of the other ports 221 from which power is being supplied is reached in the total of the maximum supplied power values. For example, the other-port-usage ratio 655 of the first port 221₁ is 0.7. Furthermore, in the case that power supply from the corresponding port 221 was stopped, the forced power supply start time zone 656 is used to indicate the time when power supply from the port 221 should be resumed regardless of the communication states of the other ports 221. A time zone immediately before the opening of the exhibition site is set herein. Although a time zone is used herein, time may also be set so as to be compatible with the processing speed of the processing shown in FIG. 11, the time data output from the clock section 216 shown in FIG. 9 and the frequency of comparison. For example, the forced power supply start time zone 656 of the first port 221₁ is set in the range of 8:50 to 9:00. The threshold value 453 and the standby time 454 are different from those shown in FIG. 8. Since the standby time 454 is in particular not necessarily used only for a time period during which the frequency of communication is assumed to become low beforehand, the standby time 454 is set longer than that of the first modification example shown in FIG. 8.

The description is continued, returning to FIG. 11. The power supply possible/impossible judgment section 632 instructs the scheduling section 631 to transmit the other-port-usage ratio 655 for the first port 221, (at step S703). The other-port-usage ratio 655 is multiplied by the total of the maximum supplied power values received at step S701, and the calculated value is obtained (at step S704). For example, in the case that the maximum supplied power value of each of the second to fourth ports 221₂ to 221₄ is 10 watts, the total value of these is 30 watts. Since the other-port-usage ratio 655 is 0.7, the calculated value is 21 watts. This calculated value is compared with the total of the measurement values of the supplied power received at step S702 (at step S705). In the case that the total of the measurement values of the supplied power has reached the calculated value (Y), the resumption judgment processing ends. The possible/impossible judgment processing proceeds to step S310 shown in FIG. 10. The port power supplying control section 233 is instructed that the power receiving apparatus detection processing is executed for the first port 221₁, and power supply is resumed. Hence, in the case that only the ports 221 from which power is being supplied may be insufficient for the access points 203, power supply to the access points 203, power supply to which is stopped, can be resumed so that they can be operated.

In addition, in the case that the total of the received measurement values of supplied power does not reach the calculated value (N at step S705), the scheduling section 631 is instructed to transmit the forced power supply start time zone 656 for the first port 221₁, and the control section 615 is instructed to transmit the current time (at step S706). If the current time is not inside the range of the forced power supply start time zone 656 (N at step S707), the processing returns to step S701, and a judgment, as to whether trouble occurs or not in the use of the wireless LAN by the visitors in the case that power is supplied only from the other ports 221₁ is repeated. On the other hand, as the time passes and becomes 8:51 on the next day, for example, the time is inside the range of the forced power supply start time zone 656 (Y), the processing ends and power supply from the first port 221₁ is resumed.

As described above, in this modification example, the state of communication is monitored depending on the power supplied from each port 221, and power supply to access points 203 to which power supply is required is stopped. After the stop, a judgment is made as to whether power supply should be resumed or not on the basis of the power supplied from each port 221 and the preset other-port-usage ratio 655. Hence, power supply to the access points 203 can be controlled depending on the communication state and power saving can be attained.

In the embodiment, in the first modification example and the second modification example, the case wherein the layer 2 switch is applied as a power supply control apparatus is described. However, the layer 2 switch is also applicable to other communication apparatuses that supply power to and perform data communication with other communication apparatuses via portst as a matter of course. Similarly, although wireless LAN access points are applied and described so as to be used as power receiving apparatuses, it is obvious that IP telephones, web cameras for monitoring and the like, work stations and other various power receiving apparatuses are applicable as power receiving apparatuses. In addition, the communication cables and connectors for connection to various apparatuses are not limited to those described above, but may be applied to other communication cables and connectors conforming to the so-called phantom power supply for supplying power from one communication apparatus to other communication apparatuses using communication cables. In addition, a protocol other than those described above may also be used for the communication between the maintenance terminal and the power supply control apparatus, and the operation function of the maintenance terminal may be provided in the power supply control apparatus. Furthermore, the power supply possible/impossible judgment section may be configured so that the power supply possibility/impossibility for each port can be indicated from the maintenance terminal so as to interrupt the power supply possible/impossible judgment processing.

Still further, although the detection as to whether a power receiving apparatus is connected to a port or not is performed on the basis of the current value obtained when a pulse voltage is applied to a power supply terminal, similar detection may also be performed using a specific terminal other than the power supply terminal. In this case, since the power being supplied does not compete with the power being used for the detection, voltage application can be performed regardless of the state of power supply, on the premise that the power receiving apparatus is also provided with a detection resistor connected to the corresponding terminal,

What is claimed is:

1. A power supply control apparatus comprising:
one or a plurality of connectors, each provided with a plurality of connection terminals and part or all of the connection terminals being power supply terminals for supplying power to communication apparatuses to be connected,
a time zone data storage section for storing time zone data indicating time zones during which the power supply terminals corresponding to the one or plurality of connectors should stop power supply,
a clock for sequentially outputting time data, and
a power supply control section for comparing the time data with the time zone data stored in the time zone data storage section and for turning ON/OFF power supply depending on the result of the comparison, for respective power supply terminals of the connector.

2. A power supply control apparatus comprising:
one or a plurality of connectors, each provided with a plurality of connection terminals and part or all of the connection terminals being power supply terminals for supplying power to communication apparatuses to be connected,
a power supply possible/impossible table for registering the possibility/impossibility of power supply in correspondence with the one or plurality of connectors,
a connection confirmation signal application section for applying a signal, for confirming the connection of a communication apparatus to which power is to be supplied, to the respective power supply terminals of each connector registered to be “power supply impossible” in the power supply possible/impossible table,
a power supply ON/OFF judgment section for sequentially judging whether power supply using each connector registered to be “power supply possible” in the power supply possible/impossible table is performed or not,
a first power supply possible/impossible table renewal section for renewing the content indicating that, when it is confirmed by the application of the connection confirmation signal from the connection confirmation signal application section that a communication apparatus to which power is to be supplied is connected, the connection of the communication apparatus to the corresponding connector registered in the power supply possible/impossible table is present,
a second power supply possible/impossible table renewal section for renewing the content indicating that, when it is judged by the power supply ON/OFF judgment section that power supply is not performed, power supply is impossible for the corresponding connector registered in the power supply possible/impossible table,
a time zone data storage section for storing time zone data indicating non-power-supply time zones each serving as a time zone during which the power supply terminals should stop power supply to the communication apparatus connected to each connector, in correspondence with respective connectors,
a clock for sequentially outputting time data, and
a power supply control section wherein the time data is compared with the corresponding time zone data stored in the time zone data storage section for each connector registered to be “power supply possible” in the power supply possible/impossible table, power supply using the connector is turned ON/OFF according to the result of the comparison, and for each connector registered to be “power supply impossible” in the power supply possible/impossible table, power supply using the connector is not performed.

3. A power supply control apparatus according to claim 2, wherein the first power supply possible/impossible table renewal section comprising:
a response content storage section for previously storing a predetermined response content obtained when a communication apparatus to which power is to be supplied is connected to the connector and the connection confirmation signal is output from the connector, and
a connection confirmation section for confirming that a communication apparatus to which power is to be supplied is connected, by comparing the response content obtained in response to the application of the connection confirmation signal from the connection confirmation signal application section with the predetermined response content stored in the response content storage section.

4. A power supply control apparatus according to claim 2, wherein the power supply control section comprises:
a non-power-supply time zone reaching judgment section for judging whether the corresponding non-power-supply time zone is reached, by comparing the corresponding time zone data stored in the time zone data storage section with the time data output from the clock, after it is judged by the power supply ON/OFF judgment section that power supply is performed,
a power supply stop section for stopping power supply using the corresponding connector after the non-power-supply time zone reaching judgment section judges that the non-power-supply time zone is reached,
a non-power-supply time zone end monitoring section for monitoring the end of the corresponding non-power-supply time zone by sequentially comparing the time data output from the clock with the corresponding time zone data stored in the time zone data storage section after power supply is stopped by the power supply stop section, and
a power supply possible/impossible table renewal stop section for not instructing the second power supply possible/impossible table renewal section to renew the corresponding content in the power supply possible/impossible table until the non-power-supply time zone end monitoring section confirms the end of the non-power-supply time zone.

5. A power supply control apparatus according to claim 3, wherein the power supply control section comprises:
a non-power-supply time zone reaching judgment section for judging whether the corresponding non-power-supply time zone is reached, by comparing the corresponding time zone data stored in the time zone data storage section with the time data output from the clock, after it is judged by the power supply ON/OFF judgment section that power supply is performed,
a power supply stop section for stopping power supply using the corresponding connector after the non-power-supply time zone reaching judgment section judges that the non-power-supply time zone is reached,
a non-power-supply time zone end monitoring section for monitoring the end of the corresponding non-power-supply time zone by sequentially comparing the time data output from the clock with the corresponding time zone data stored in the time zone data storage section after power supply is stopped by the power supply stop section, and
a power supply possible/impossible table renewal stop section for not instructing the second power supply possible/impossible table renewal section to renew the corresponding content in the power supply possible/impossible table until the non-power-supply time zone end monitoring section confirms the end of the non-power-supply time zone.

6. A power supply control apparatus according to claim 4, further comprising:
a power threshold value storage section for storing, in correspondence with each connector, a power threshold value being used as a criterion according to which it is judged that a communication apparatus to which power is to be supplied and which is connected to the connector requires power supply using the connector,
a time threshold value storage section for storing, in correspondence with each connector, a time threshold value being used as a criterion according to which it is judged that the frequency in which a communication apparatus to which power is to be supplied and which is connected to the connector requires power supply using the connector is lowered to the extent that no trouble occurs even if the power supply is stopped,
an elapsed time measurement section for starting the measurement of elapsed time in correspondence with each connector after the non-power-supply time zone reaching judgment section judges that the non-power-supply time zone is reached,
a power measurement value section for sequentially measuring, for each connector, the value of power supplied from the power supply control section using the power supply terminals of the connector at which the elapsed time measurement section started the measurement,
a power threshold value reaching judgment section for sequentially judging whether the power measurement value of the power measurement value section has reached the corresponding power threshold value stored in the power threshold value storage section or not,
an elapsed time initialization section for instructing the elapsed time measurement section to initialize the time measurement value for the corresponding connector and to restart measurement when the power threshold value reaching judgment section judges that the power measurement value reaching judgment section has reached the power threshold value, and
a time threshold value reaching judgment section for judging whether the corresponding time measurement value obtained by the elapsed time measurement section has reached the corresponding time threshold value stored in the time threshold value storage section or not when the power threshold value reaching judgment section judges that the power measurement value has not reached the power threshold value, wherein
the power supply stop section stops power supply using the corresponding connector after the time threshold value reaching judgment section judges that the time measurement value has reached the time threshold value.

7. A power supply control apparatus according to claim 5, further comprising:
a power threshold value storage section for storing, in correspondence with each connector, a power threshold value being used as a criterion according to which it is judged that a communication apparatus to which power is to be supplied and which is connected to the connector requires power supply using the connector,
a time threshold value storage section for storing, in correspondence with each connector, a time threshold value being used as a criterion according to which it is judged that the frequency in which a communication apparatus to which power is to be supplied and which is connected to the connector requires power supply using the connector is lowered to the extent that no trouble occurs even if the power supply is stopped,
an elapsed time measurement section for starting the measurement of elapsed time in correspondence with each connector after the non-power-supply time zone reaching judgment section judges that the non-power-supply time zone is reached,
a power measurement value section for sequentially measuring, for each connector, the value of power supplied from the power supply control section using the power supply terminals of the connector at which the elapsed time measurement section started the measurement,
a power threshold value reaching judgment section for sequentially judging whether the power measurement value of the power measurement value section has reached the corresponding power threshold value stored in the power threshold value storage section or not,
an elapsed time initialization section for instructing the elapsed time measurement section to initialize the time measurement value for the corresponding connector and to restart measurement when the power threshold value reaching judgment section judges that the power measurement value reaching judgment section has reached the power threshold value, and
a time threshold value reaching judgment section for judging whether the corresponding time measurement value obtained by the elapsed time measurement section has reached the corresponding time threshold value stored in the time threshold value storage section or not when the power threshold value reaching judgment section judges that the power measurement value has not reached the power threshold value, wherein
the power supply stop section stops power supply using the corresponding connector after the time threshold value reaching judgment section judges that the time measurement value has reached the time threshold value.

8. A power supply control apparatus comprising:
one or a plurality of connectors, each provided with a plurality of connection terminals and part or all of the connection terminals being power supply terminals for supplying power to communication apparatuses to be connected,
a connection confirmation signal application section for applying a signal, for confirming the connection of a communication apparatus to which power is to be supplied at predetermined timing, to the power supply terminals of each connector,
a power supply start section for starting power supply using the corresponding connector when it is confirmed by the application of the connection confirmation signal from the connection confirmation signal application section that a communication apparatus to which power is to be supplied is connected,
a power threshold value storage section for storing, in correspondence with each connector, a power threshold value being used as a criterion according to which it is judged that a communication apparatus connected to the connector requires power supply using the connector,
a time threshold value storage section for storing, in correspondence with each connector, a time threshold value being used as a criterion according to which it is judged that the frequency in which a communication apparatus connected to the connector requires power supply using the connector is lowered to the extent that no trouble occurs even if the power supply is stopped,
an elapsed time measurement section for starting the measurement of elapsed time in correspondence with each connector to which power supply is started by the power supply start section,
a power measurement value section for sequentially measuring, for each connector, the value of supplied power using the power supply terminals of the connector at which the elapsed time measurement section started the measurement,
a power threshold value reaching judgment section for judging whether the power measurement value obtained by the power measurement value section has reached the corresponding power threshold value stored in the power threshold value storage section or not,
an elapsed time initialization section for instructing the elapsed time measurement section to initialize the time measurement value for the corresponding connector and to restart measurement when the power threshold value reaching judgment section judges that any one of the power measurement values has reached the corresponding power threshold value,
a time threshold value reaching judgment section for sequentially judging whether each time measurement value obtained by the elapsed time measurement section has reached the corresponding time threshold value stored in the time threshold value storage section or not, and
a power supply stop section for stopping power supply using the corresponding connector when the time threshold value reaching judgment section judges that any one of the time measurement values has reached the corresponding time threshold value.

9. A power supply control apparatus according to claim 8, further comprising:
a response content storage section for previously storing a predetermined response content obtained when a communication apparatus to which power is to be supplied is connected to the connector and the connection confirmation signal is output from the connector, wherein
the power supply start section is provided with a connection confirmation section for confirming that a communication apparatus to which power is to be supplied is connected, by comparing the response content obtained in response to the application of the connection confirmation signal from the connection confirmation signal application section with the predetermined response content stored in the response content storage section.

10. A power supply control method comprising the steps of:
detecting a communication apparatus to which power is to be supplied when the communication apparatus is newly connected to one or any one of the a plurality of connectors, each provided with a plurality of connection terminals and part or all of the connection terminals being power supply terminals for supplying power to communication apparatuses to be connected,
starting power supply, when it is detected by the connection detection that a communication apparatus to which power is to be supplied is newly connected to any one of the connectors, to the communication apparatus connected to the corresponding connector using the connector,
sequentially comparing time data output from a clock with the corresponding time zone data in the time zone data indicating non-power-supply time zones each serving as a time zone during which the respective power supply terminals should stop power supply, the time zone being stored in a time zone data storage section in correspondence with each connector to which power supply is started by the start of power supply and of monitoring the reaching of each non-power-supply time zone,
stopping power supply using the corresponding connector when it is judged by the monitoring of the reaching of the non-power-supply time zone that any one of the non-power-supply time zones is reached,
sequentially comparing the time data with the corresponding time zone data in the time zone data storage section, for each connector, power supply to which is stopped by the power supply stop, and of monitoring the end of each non-power-supply time zone, and
resuming power supply using the corresponding connector when it is judged by the non-power-supply time zone end monitoring that any one of the non-power-supply time zones is ended.
